(19) United States
(12) Patent Application Publication
(10) Pub. No.: US 2026/0340423 A1
(43) Pub. Date: Oct. 29, 2026

(54) ASSISTANCE APPARATUS, ASSISTANCE METHOD, AND STORAGE MEDIUM

(71) Applicant: NEC Corporation, Minato-ku, Tokyo (JP)

(72) Inventor: Riki ETO, Tokyo (JP)

(73) Assignee: NEC Corporation, Minato-ku, Tokyo (JP)

(21) Appl. No.: 19/123,430

(22) PCT Filed: Oct. 31, 2022
(86) PCT No.: PCT/JP2022/040583

§ 371 Date: Apr. 23, 2025

(51) Int. Cl. G06N 5/01

(52) U.S. Cl. CPC G06N 5/01

(57) ABSTRACT

To facilitate determination of a constraint for optimization that uses an objective function, provided is an assistance apparatus (1) including: a variable extraction section (11) that extracts, from training data for use in generation of an objective function, a variable corresponding to a feature of the objective function; a reference information generation section (12) that generates, based on the extracted variable, reference information for determining a constraint for optimization calculation that uses the objective function; and an information presentation section (13) that presents the reference information.

### TECHNICAL FIELD

The present invention relates to an assistance apparatus and the like that assists determination of a constraint for optimization calculation that uses an objective function.

### BACKGROUND ART

Optimization calculation using an objective function is utilized in various technical fields. For example, Patent Literature 1 below discloses a technique related to optimization control for use in industrial processes such as petroleum refining processes and petrochemical processes in order to carry out the operation in an optimum state with use of the optimization that uses an objective function.

### CITATION LIST

### Patent Literature

Japanese Patent Application Publication Tokukai No. 2015-228151

### SUMMARY OF INVENTION

### Technical Problem

Including the technique disclosed in Patent Literature 1, the optimization calculation that uses an objective function is carried out under a given constraint. Thus, an operator who carries out optimization that uses an objective function needs to set a constraint. However, setting a reasonable constraint requires knowledge and the like about an objective function or the like to be used, so that it might be difficult for some operators to determine a constraint.

An example aspect of the present invention has been made in view of this problem, and an example object thereof is to provide a technique that facilitates determination of a constraint for optimization that uses an objective function.

### Solution to Problem

An assistance apparatus in accordance with an example aspect of the present invention, includes: variable extraction means for extracting, from training data for use in generation of an objective function, a variable corresponding to a feature of the objective function; reference information generation means for generating, based on the extracted variable, reference information for determining a constraint for optimization calculation that uses the objective function; and information presentation means for presenting the reference information.

An assistance method in accordance with an example aspect of the present invention, includes: extracting, by at least one processor, from training data for use in generation of an objective function, a variable corresponding to a feature of the objective function; generating, by the at least one processor, based on the extracted variable, reference information for determining a constraint for optimization calculation that uses the objective function; and presenting the reference information by the at least one processor.

An assistance program in accordance with an example aspect of the present invention, causes a computer to function as: variable extraction means for extracting, from training data for use in generation of an objective function, a variable corresponding to a feature of the objective function; reference information generation means for generating, based on the extracted variable, reference information for determining a constraint for optimization calculation that uses the objective function; and information presentation means for presenting the reference information.

### ADVANTAGEOUS EFFECTS OF INVENTION

According to an example aspect of the present invention, it is possible to facilitate determination of a constraint for optimization that uses an objective function.

### BRIEF DESCRIPTION OF DRAWINGS

FIG. 1 is a block diagram illustrating the configuration of an assistance apparatus in accordance with a first example embodiment of the present invention.

FIG. 2 is a flowchart of an assistance method in accordance with the first example embodiment of the present invention.

FIG. 3 is a diagram for describing the outline of an assistance apparatus in accordance with a second example embodiment of the present invention.

FIG. 4 is a block diagram illustrating the configuration of the assistance apparatus.

FIG. 5 is a diagram illustrating an example of an acceptance screen for accepting specification of variables.

FIG. 6 is a diagram illustrating an example of a screen indicating statistics calculated as reference information on a bar chart.

FIG. 7 is a flowchart of an assistance method in accordance with the second example embodiment of the present invention.

FIG. 8 is a block diagram illustrating the configuration of an assistance apparatus in accordance with a third example embodiment of the present invention.

FIG. 9 is a diagram illustrating an example of a display screen of distribution information.

FIG. 10 is a flowchart of an assistance method in accordance with the third example embodiment of the present invention.

FIG. 11 is a diagram illustrating an example of a computer that executes instructions of a program which is software implementing the functions of the apparatuses in accordance with the example embodiments of the present invention.

### EXAMPLE EMBODIMENTS

### First Example Embodiment

The following description will discuss a first example embodiment of the present invention in detail with reference to the drawings. The present example embodiment is a basic form of an example embodiment described later.

### Configuration of Assistance Apparatus

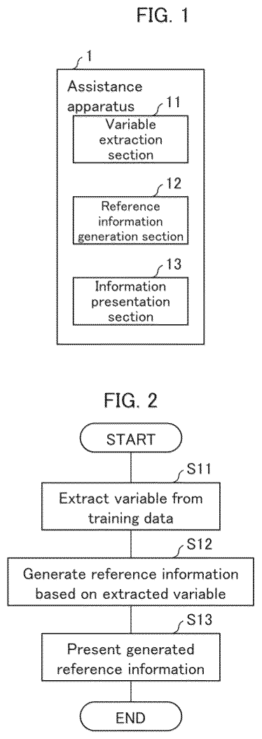

The following description will discuss the configuration of an assistance apparatus 1 in accordance with the present example embodiment with reference to FIG. 1. FIG. 1 is a block diagram illustrating the configuration of the assistance apparatus 1 in accordance with the present example embodiment. As illustrated in the figure, the assistance apparatus 1 includes a variable extraction section 11, a reference information generation section 12, and an information presentation section 13.

The variable extraction section 11 extracts, from training data for use in generation of an objective function, a variable corresponding to a feature of the objective function. The reference information generation section 12 generates, based on the variable extracted by the variable extraction section 11, reference information for determining a constraint for optimization calculation that uses the objective function. The information presentation section 13 presents the reference information generated by the reference information generation section 12.

As described in the foregoing, the assistance apparatus 1 in accordance with the present example embodiment employs a configuration in which the apparatus includes: the variable extraction section 11 that extracts, from training data for use in generation of an objective function, a variable corresponding to a feature of the objective function; the reference information generation section 12 that generates, based on the variable extracted by the variable extraction section 11, reference information for determining a constraint for optimization calculation that uses the objective function; and the information presentation section 13 that presents the reference information generated by the reference information generation section 12. Therefore, according to the assistance apparatus 1 in accordance with the present example embodiment, it is possible to achieve an example advantage of being capable of facilitating determination of a constraint for optimization that uses an objective function.

### Assistance Program

The above functions of the assistance apparatus 1 can be implemented by a program. An assistance program in accordance with the present example embodiment causes a computer to function as: the variable extraction section 11 that extracts, from training data for use in generation of an objective function, a variable corresponding to a feature of the objective function; the reference information generation section 12 that generates, based on the variable extracted by the variable extraction section 11, reference information for determining a constraint for optimization calculation that uses the objective function; and the information presentation section 13 that presents the reference information generated by the reference information generation section 12. According to the assistance program, it is possible to achieve an example advantage of being capable of facilitating determination of a constraint for optimization that uses an objective function.

### Flow of Assistance Method

The following description will discuss the flow of an assistance method in accordance with the present example embodiment with reference to FIG. 2. FIG. 2 is a flowchart illustrating the flow of the assistance method in accordance with the present example embodiment. Here, steps of the training method may be carried out by a processor of the assistance apparatus 1 or by a processor of another apparatus. Alternatively, the steps may be carried out by processors provided in respective different apparatuses.

In S11, at least one processor extracts, from training data for use in generation of an objective function, a variable corresponding to a feature of the objective function. Next, in S12, the at least one processor generates, based on the variable extracted in S11, reference information for determining a constraint for optimization calculation that uses the objective function. Then, in S13, the at least one processor presents the reference information generated in S12.

As described in the foregoing, the assistance method in accordance with the present example embodiment employs a configuration in which the method includes: extracting, by at least one processor, from training data for use in generation of an objective function, a variable corresponding to a feature of the objective function; generating, by the at least one processor, based on the extracted variable, reference information for determining a constraint for optimization calculation that uses the objective function; and presenting the generated reference information by the at least one processor. Therefore, according to the assistance method in accordance with the present example embodiment, it is possible to achieve an example advantage of being capable of facilitating determination of a constraint for optimization that uses an objective function.

### Second Example Embodiment

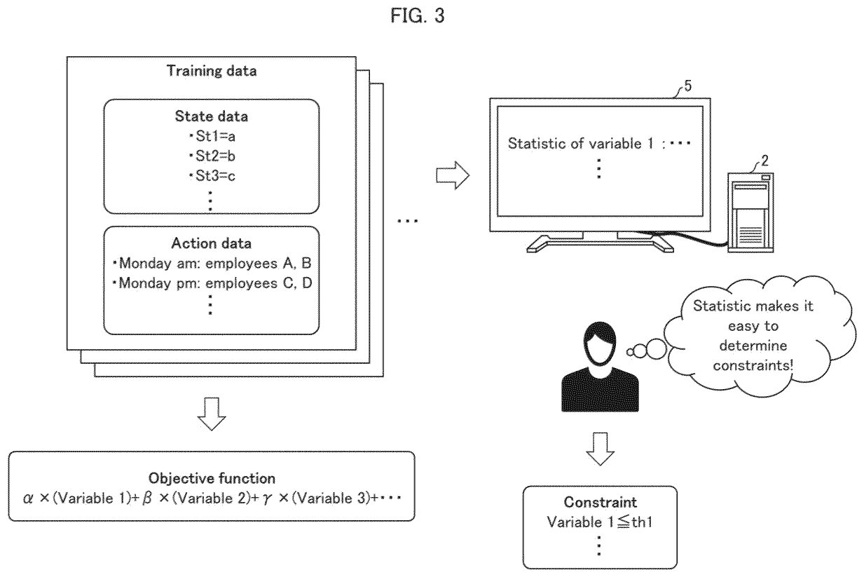

Outline The following description will discuss the outline of an assistance apparatus 2 in accordance with a second example embodiment of the present invention, with reference to FIG. 3. FIG. 3 is a diagram for describing the outline of the assistance apparatus 2 in accordance with the second example embodiment of the present invention. The assistance apparatus 2 is an apparatus that assists optimization calculation that uses an objective function, and more particularly, the assistance apparatus 2 is an apparatus that facilitates determination of a constraint for use in the optimization calculation.

Although FIG. 3 illustrates an example in which the assistance apparatus 2 is a desktop personal computer, this is merely an example. The assistance apparatus 2 may be implemented by a general-purpose computer such as a personal computer or a smartphone, may be implemented as an apparatus that has a main function of assisting determination of a constraint, and may be a stationary apparatus or a portable apparatus.

The assistance apparatus 2 extracts, from training data for use in generation of an objective function, a variable corresponding to a feature of the objective function. Here, if a variable included in the training data is used as a feature of the objective function as it is, the assistance apparatus 2 extracts the variable, whereas, if a feature of the objective function is calculated from one or more variables included in the training data, the assistance apparatus 2 extracts one or more variables for use in the calculation of the feature.

The training data illustrated in FIG. 3 is data in which state data and action data are associated with each other. The action data indicates actions that are preferable to be taken in states indicated by the state data. The training data may be generated based on actions carried out in the past (those can be said to be reasonable actions) and states each being created in response to the corresponding action carried out. In this case, the training data may be reworded as historical data indicating the history of decision making about the actions.

Here, it is assumed that the objective function is generated by inverse reinforcement learning. Therefore, it is sufficient to prepare pieces of the training data as many as necessary for the inverse reinforcement learning. Since the inverse reinforcement learning usually uses a plurality of pieces of training data, the assistance apparatus 2 extracts a variable from each piece of the training data. Note that the objective function is not limited to that being generated by the inverse reinforcement learning, but may be any function that is generated by using the training data. For example, the objective function may be generated by a known machine learning technique such as density ratio estimation.

Various kinds of pieces of action data can be applied. For example, in a case where the objective function creates a schedule, data indicating a schedule conforming to the state indicated by the state data may be adopted as the action data. For example, in the case of creation of a work schedule for each employee, data indicating employees in each time slot as illustrated in FIG. 3 may be used as the action data.

Further, for example, in a case where the objective function is used to carry out resource allocation or matching, data indicating resource allocation or combination conforming to the state indicated by the state data may be adopted as the action data. Similarly, in a case where the objective function is used to carry out order determination, optimal path search, or automatic control, data indicating the order, path, or details on control, conforming to the state indicated by the state data may be adopted as the action data.

Further, the state data may be any data that indicates a state at the time at which an action indicated by the action data is taken, and the state may be expressed by a plurality of variables (St1, St2, . . . ) as illustrated in the figure. For example, in the case of creation of a work schedule for each employee, a variable indicating the cumulative overtime hours of each employee and a variable indicating the maximum daily working hours may be used as the state data. The assistance apparatus 2 extracts such variables from the training data. Here, the state data may be used as a feature of the objective function as it is, and in some cases, the variable may be used to calculate a feature of the objective function.

Next, the assistance apparatus 2 generates, based on the extracted variable, reference information for determining a constraint for optimization calculation that uses the objective function. Then, the assistance apparatus 2 presents the generated reference information to an operator who operates the assistance apparatus 2 (i.e., person who determines a constraint). The reference information may be any information that can be generated based on the extracted variable, and serves as a reference for determining a constraint. Further, the mode of presentation of the reference information is not particularly limited.

In the example of FIG. 3, the assistance apparatus 2 displays statistics calculated for variables included in the state data extracted from the training data, on a display apparatus 5 as the reference information. If the statistics of the variables extracted from the training data are known, it is possible to easily determine a reasonable constraint. Thus, the assistance apparatus 2 can allow the constraint to be easily determined. In the example of FIG. 3, with reference to the statistic of variable 1, the operator determines a constraint in which the variable 1 is not more than threshold th1 (variable 1≤sth1).

By carrying out the optimization calculation that uses the constraint thus determined and the objective function generated by using the training data, it is possible to infer actions preferable to be taken in respective states. For example, in a case where the action data included in the training data indicates work schedules of the employees, optimization calculation may be carried out using the state data indicating states each affecting the work schedules as input data. Thus, it is possible to infer a schedule preferable to be adopted depending on the state.

The form of the objective function is not particularly limited. For example, in a case where an objective function is generated by inverse reinforcement learning, a mathematical expression in which each feature is multiplied by a weighting value and the obtained values are added may be used as the objective function. In the example of FIG. 3, weighting values of variables 1 to 3, which are features, are a to y, respectively. It can be said that each feature indicates a factor affecting the actions or a viewpoint emphasized in determination of the actions. Further, each weighting value by which a feature is multiplied indicates how much the factor or viewpoint is emphasized, and is learned by using the training data.

The optimization calculation may be carried out with an optimization solver. As the optimization solver, for example, a common application program such as IBM ILOG CPLEX, Gurobi Optimizer, S CIP, and the like may be used. The assistance apparatus 2 may carry out either or both of the generation of the objective function and the optimization calculation.

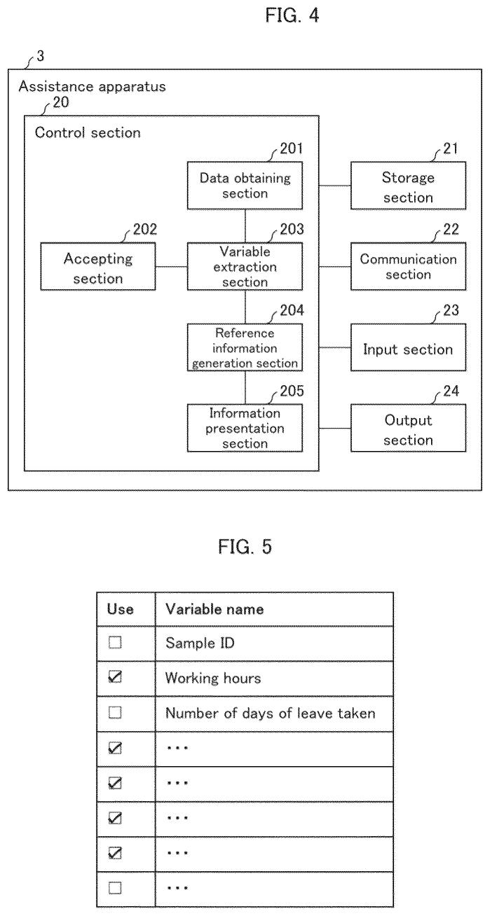

(Configuration of assistance apparatus) The following description will discuss the configuration of the assistance apparatus 2 in accordance with the present example embodiment with reference to FIG. 4. FIG. 4 is a block diagram illustrating the configuration of the assistance apparatus 2. As illustrated in the figure, the assistance apparatus 2 includes a control section 20 that collectively controls sections of the assistance apparatus 2 and a storage section 21 in which various kinds of data used by the assistance apparatus 2 are stored. Further, the assistance apparatus 2 includes: a communication section 22 that allows the assistance apparatus 2 to communicate with other apparatuses; an input section 23 that receives input of various kinds of data to the assistance apparatus 2; and an output section 24 that allows the assistance apparatus 2 to output various kinds of data. Further, the control section 20 includes a data obtaining section 201, an accepting section 202, a variable extraction section 203, a reference information generation section 204, and an information presentation section 205.

The data obtaining section 201 obtains training data for use in generation of an objective function. The method of obtaining training data is not particularly limited, and for example, the data obtaining section 201 may obtain training data inputted via the input section 23 or may obtain training data from another apparatus via the communication section 22.

The accepting section 202 accepts specification of a variable for use in generation of reference information. For example, the accepting section 202 may accept the specification of variables by displaying a screen as illustrated in FIG. 5. FIG. 5 is a diagram illustrating an example of an acceptance screen for accepting the specification of variables. In the acceptance screen illustrated in the figure, variable names and check boxes are shown in association with each other. The operator can check the check boxes via the input section 23. The accepting section 202 sets variables corresponding to the checked check boxes to variables for use in the generation of the reference information.

The variable extraction section 203 extracts a variable corresponding to a feature of the objective function from the training data obtained by the data obtaining section 201. For example, if training data in which state data and action data are associated is obtained as in the example of FIG. 3, the variable extraction section 203 may extract variables included in the state data. Note that the variable extraction section 203 may extract the variable in a case where the variable included in the training data is set to the feature of the objective function as it is. Further, in a case where the feature of the objective function is calculated from one or more variables included in the training data, the variable extraction section 203 may extract one or more variables for use in calculation of the feature.

The reference information generation section 204 generates the reference information for determining a constraint for optimization calculation that uses the objective function based on the variable extracted by the variable extraction section 203. Here, in a case where the accepting section 202 has accepted specification of a variable for use in generation of the reference information, the reference information generation section 204 generates the reference information based on a variable specified to be used for the generation of the reference information from among variables extracted by the variable extraction section 203.

Thus, the assistance apparatus 2 includes the accepting section 202 that accepts specification of a variable, and the reference information generation section 204 generates reference information based on the specified variable. Thus, in addition to the example advantage achieved by the assistance apparatus 1 in accordance with the first example embodiment, the assistance apparatus 2 in accordance with the present example embodiment can achieve an example advantage of being capable of presenting, to the operator who has specified a variable of interest, the reference information generated based on the variable.

As described above, the reference information may be, for example, a statistic of the extracted variable. Specifically, the reference information may be at least one of values of the extracted variable, such as a mean value, a median value, a maximum value, a minimum value, a mode value, a variance, a deviation, and a standard deviation. For example, in a case where the mean value of “St1” included in the state data in the example of FIG. 3 is used as the reference information, the reference information generation section 204 may use, as the reference information, a value obtained by dividing the sum of the values of “St1” extracted by the variable extraction section 203 from the training data, by the total number of extracted “St1”.

The information presentation section 205 presents the reference information generated by the reference information generation section 204 to the t operator. The mode of presentation is not particularly limited; for example, the information presentation section 205 may display the reference information on the display apparatus, may cause the audio output apparatus to output the reference information by voice, or may make a printout of the reference information by a printing apparatus. The apparatus for outputting the reference information may be an apparatus included in the assistance apparatus 2 or may be an apparatus external to the assistance apparatus 2. For example, the information presentation section 205 may cause the output section 24 to output the reference information, or may cause the display apparatus 5 external to the assistance apparatus 2 to output the reference information as illustrated in the example of FIG. 3.

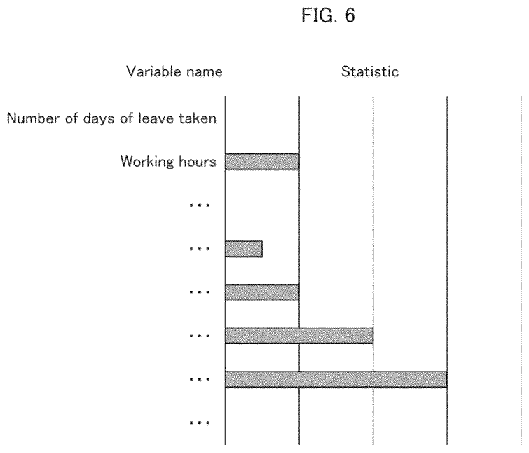

Further, in a case where the reference information is a statistic, the information presentation section 205 may present a numerical value indicating the statistic or may present a graph indicating the statistic. FIG. 6 is a diagram illustrating an example of a screen indicating statistics calculated as the reference information on a bar chart. For example, indicating the variance of each variable by a bar chart in this way enables the operator to easily ascertain a variable having a large variance, so that it is also possible to broadly set a constraint that defines a range of such variables.

Further, the information presentation section 205 may present, in addition to the reference information, a weighting value corresponding to each variable. Note that the weighting value is determined by training using training data. Since the weighting value corresponding to each variable indicates the degree of emphasis put on the variable, it serves as a reference in determining for which variable what kind of constraint is set.

### Use of Mathematical Expression

Further, instead of the statistic of the variable extracted by the variable extraction section 203, the reference information generation section 204 may calculate a statistic of a value obtained by substituting the variable into a predetermined mathematical expression. For example, in general optimization calculation, the following constraints may be used as constraints of variable x. Here, a to c are constants.

ax+b>c . . . (1)

ax+b<c . . . (2)

ax+b=c . . . (3)

Then, the reference information generation section 204 may substitute the variable x extracted by the variable extraction section 203 into, for example, the mathematical expression “ax+b”, to calculate the statistic of the value as the reference information. This allows the reference information to be presented to the operator for reference in making the constraint expressions as described above.

Further, to calculate the feature of the objective function from one or more variables included in the training data, the statistic of the feature may be calculated. In this case, the variable extraction section 203 extracts one or more variables for use in calculation of the feature, and the reference information generation section 204 calculates the feature from each piece of the training data by using the one or more variables, to calculate the statistic thereof.

Further, for example, in a case where the objective function is used to produce a production plan of a plurality of items, the variable extraction section 203 may extract a variable indicating the production amounts of the respective items. In this case, the reference information generation section 204 may calculate the sum of the production amounts of the items, that is, a statistic of the total production amount of all the items, and may set the statistic to the reference information. In this case, if it is assumed that the number of items is n (n is an integer of 3 or more), the predetermined mathematical expression is “the production amount of item 1+the production amount of item 2+ . . . + the production amount of item n”. Thus, it is possible to present to the operator the reference information for reference in setting the total production amount of all items to the constraint.

As described above, the reference information generation section 204 may calculate a statistic of the variable extracted by the variable extraction section 203 or a statistic of a value obtained by substituting the variable into a predetermined mathematical expression, and may set the calculated statistic as the reference information.

If the statistic of the variable extracted from the training data is known, it is possible to easily determine a reasonable constraint. The same applies to the statistic of the value obtained by substituting the variable extracted from the training data into the predetermined mathematical expression. Therefore, according to the foregoing configuration in which the statistic of the variable extracted from the training data or the statistic of the value obtained by substituting the variable into the predetermined mathematical expression is used as the reference information, and this reference information is presented, it is possible to facilitate determination of a constraint.

### Switching of Training Data to be Subjected to Extraction

The variable extraction section 203 may sort the training data obtained by the data obtaining section 201 into a plurality of segments and extract a variable from the training data of each segment. In this case, the reference information generation section 204 generates pieces of the reference information corresponding to the respective sections based on the variable extracted from the training data of each section, the information presentation section 205 presents the pieces of the reference information for each segment.

Accordingly, in addition to the example advantage achieved by the assistance apparatus 1 in accordance with the first example embodiment, it is possible to achieve an example advantage of being capable of providing useful information for an operator's determination as to which segment of training data the generation of an objective function uses. Note that the above reference information only needs to be information that can be used as a reference for determining a constraint. For example, it may be a statistic described above, or may be distribution information to be described in a third example embodiment described later.

For example, in a case where the training data is data related to a work schedule for the past year of the employees, the variable extraction section 203 may sort the training data into segments of each predetermined period. For example, in a case where the variable extraction section 203 sorts the training data by month, the reference information generation section 204 calculates a statistic (e.g., mean working hours) corresponding to each month based on variables extracted from the training data of each month, and the information presentation section 205 presents the calculated statistics on a monthly basis. The information presentation section 205 may present to the operator the statistics by month by displaying them on a single screen, for example. Alternatively, the information presentation section 205 may present statistics of some of months on a single screen and allows the operator to switch over the months displayed. This allows the operator to avoid using, in generation of an objective function, for example, training data of specific months from which the values of the statistic that are significantly different from those of other months are obtained. This makes it possible to generate a general-purpose objective function by using mean training data.

### Flow of Processing

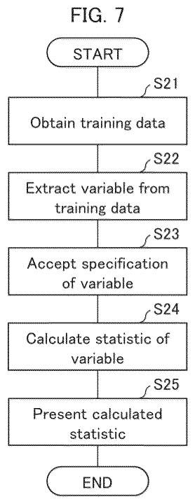

The following description will discuss the flow of processing carried out by the assistance apparatus 2 (assistance method) with reference to FIG. 7. FIG. 7 is a flowchart of the assistance method in accordance with the second example embodiment.

In S21, the data obtaining section 201 obtains training data for use in generation of an objective function. Subsequently, in S22, the variable extraction section 203 extracts variables from the training data obtained in S21. The variables extracted in S22 are variables corresponding to features of the objective function generated by using the training data obtained in S21.

In S23, the accepting section 202 receives the specification of one or more variables. For example, the accepting section 202 may present to the operator the variable name of each variable extracted in S22 by displaying the acceptance screen as illustrated in FIG. 5, to accept the specification of one or more variables carried out by the operator. Thus, the variables are narrowed down to one or more variables for use in generation of the reference information in accordance with the one or more variables specified by the operator.

Note that narrowing down to the one or more variables for use in generation of the reference information may be carried out by the variable extraction section 203. For example, the variable extraction section 203 may obtain a weighting value of the objective function corresponding to each extracted variable, and may use a variable(s) each having the weighting value of not less than a predetermined threshold as the one or more variables for use in generation of the reference information. Thus, it is possible to generate the reference information by narrowing down the variables to one or more variables each having a large influence on optimization calculation. Further, for example, the variable extraction section 203 may use the following variables as the one or more variables for use in generation of the reference information: a variable included in a constraint set in the past; a variable that has been used frequently under a constraint set in the past, or a variable of the same kind as these variables. For example, if pieces of information each indicating a variable that has been used in the determined constraint and the type thereof are accumulated, the variable extraction section 203 can narrow down the variables by using the information. The accepting section 202 may allow the operator to specify one or more variables for use in generation of the reference information from among the variables narrowed down in this way.

In S24, the reference information generation section 204 calculates the statistic of the one or more variables specified in S23. As described above, the statistic is the reference information for determining a constraint for optimization calculation that uses the objective function generated by using the training data obtained in S21. Then, in S25, the information presentation section 205 presents to the operator the statistic calculated in S25, and the operation of FIG. 7 is terminated.

### Third Example Embodiment

### Configuration of Assistance Apparatus

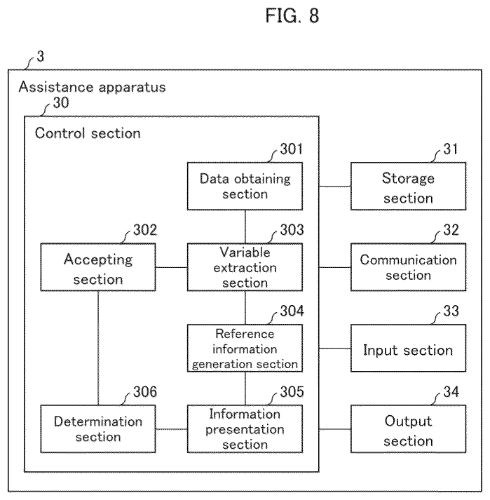

The following description will discuss the configuration of an assistance apparatus 3 in accordance with the present example embodiment with reference to FIG. 8. FIG. 8 is a block diagram illustrating the configuration of the assistance apparatus 3. As illustrated in the figure, the assistance apparatus 3 includes a control section 30 that collectively controls sections of the assistance apparatus 3 and a storage section 31 in which various kinds of data used by the assistance apparatus 3 are stored. Further, the assistance apparatus 3 includes: a communication section 32 that allows apparatuses; an input section 33 that receives input of various kinds of data to the assistance apparatus 3; and an output section 34 that allows the assistance apparatus 3 to output various kinds of data. Further, the control section 30 includes a data obtaining section 301, an accepting section 302, a variable extraction section 303, a reference information generation section 304, an information presentation section 305, and a determination section 306. Here, the data obtaining section 301 has the same configuration as the data obtaining section 201 of the second example embodiment, and the variable extraction section 303 has the same configuration as the variable extraction section 203 of the second example embodiment.

The reference information generation section 304 generates distribution information indicating the distribution of a variable extracted by the variable extraction section 303. The distribution information is the reference information for determining a constraint for optimization calculation that uses an objective function generated by using the training data obtained by the data obtaining section 301. That is, the reference information generation section 304 generates the distribution information as the reference information. Also in the generation of the distribution information, a value obtained by substituting the variable into the predetermined mathematical expression instead of the extracted variable may be used as in the item “Use of mathematical expression” described above.

If the distribution of the variable extracted from the training data or the distribution of the value obtained by substituting the variable into the predetermined mathematical expression is known, it is possible to easily determine a reasonable constraint. Therefore, according to the foregoing configuration in which the information indicating the distribution of the variable is generated as the reference information and the information is presented, it is possible to facilitate determination of the constraint.

The accepting section 302 accepts specification of a threshold. The acceptance of the specification of the threshold will be described below with reference to the item “Example of display screen of distribution information” described later. Similarly to the accepting section 202 of the second example embodiment, the accepting section 302 may accept the specification of a variable for use in the generation of the reference information.

The determination section 306 determines whether or not the constraint is satisfied based on the threshold accepted by the accepting section 302 and the variable extracted by the variable extraction section 303. Details of the determination will be described below in the item “Example of display screen of distribution information”.

The information presentation section 305 presents the reference information generated by the reference information generation section 304 to the operator. Further, the information presentation section 305 presents to the operator the relevant information related to a variable which has been determined not to satisfy the constraint by the determination section 306. The relevant information will be described below in the item “Example of display screen of distribution information”.

### Example of Display Screen of Distribution Information

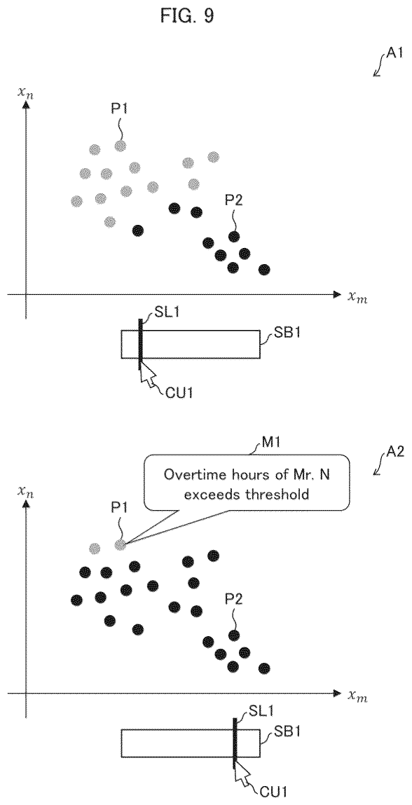

In a case where the distribution information is presented in a presentation mode of displaying output, the information presentation section 305 may display, for example, a screen as illustrated in FIG. 9. FIG. 9 is a diagram illustrating an example of the display screen of the distribution information. FIG. 9 illustrates an example of two display screens A1 and A2. Each of the display screen examples A1 and A2 displays the distribution information representing a distribution of variables on a scatter diagram. Of course, the distribution information only needs to be information that indicates the distribution of variables, and is not limited to a scatter diagram. For example, the distribution information may be a frequency distribution diagram of a variable or the like, or alternatively, the distribution information may be numerical information such as a combination of a mean value of a variable and a value of variance thereof.

In a case where the distribution information is a scatter diagram, the information presentation section 305 selects, from among variables extracted by the variable extraction section 303, a variable to be assigned to the vertical axis of the scatter diagram and a variable to be assigned to the horizontal axis thereof. Here, the variable to be assigned to the vertical axis and the variable to be assigned to the horizontal axis may be specified by the operator. In this case, the accepting section 302 may display, for example, a screen enumerating selectable variables as in FIG. 5, to accept the specification of variables.

The information presentation section 305, which selects the variables to be assigned to the vertical and horizontal axes, draws a coordinate plane defined by the selected two axes and plots points representing the values of the two variables on the coordinate plane. Thus, scatter diagrams as illustrated in the display screen examples A1 and A2 are drawn.

For example, in a case where it is assumed that the cumulative working hours in a predetermined period is employed as the variable assigned to the vertical axis and the cumulative number of days of leave taken in a predetermined period is employed as the variable assigned to the horizontal axis, the information presentation section 305 draws a coordinate plane in FIG. 9 with the horizontal axis xₘ to which the cumulative number of days of leave taken is assigned and the vertical axis xₙ to which the cumulative working hours is assigned. Then, the information presentation section 305 plots points corresponding to the cumulative working hours and the cumulative number of days of leave taken of each employee on the coordinate plane. In this case, the points on the coordinate plane represent the cumulative working hours and the cumulative number of days of leave taken of respective employees.

Further, each of the display screen examples A1 and A2 includes a slider bar SB1 and a slider SL. The slider bar SB1 and the slider SL are objects with which a threshold is specified. Here, this threshold is a threshold that is for use as a constraint regarding the variable extracted by the variable extraction section 303. For example, the threshold may define one or both of the upper limit and the lower limit of the variable, or alternatively, the threshold may define one or both of the upper limit and the lower limit of a value calculated by using the variable.

More particularly, the slider bar SB1 indicates a range of the threshold that can be specified, and the position of the slider SL on the slider bar SB1 indicates the threshold. Then, the operator can use a cursor CU1 to move the slider SL, to thereby change the position of the slider SL over the slider bar SB1. This allows the operator to specify the threshold. Then, the accepting section 302 identifies the specified threshold based on the position of the slider SL on the slider bar SB1.

In this way, upon accepting the specification of the threshold by the accepting section 302, the determination section 306 determines whether or not the constraint is satisfied based on the threshold accepted by the accepting section 302 and the variable extracted by the variable extraction section 303. Then, the information presentation section 305 selects the presentation mode of the variable in the scatter diagram in accordance with the determination result.

For example, if a constraint that the overtime hours of each employee are not more than the threshold is employed, the information presentation section 305 may display the slider bar SB1 and the slider SL for accepting specification of the threshold of overtime hours. Further, the accepting section 302 identifies the specified threshold based on the position of the slider SL on the slider bar SB1, and the determination section 306 determines whether or not the overtime hours is not more than the specified threshold for each point plotted in the scatter diagram. Then, the information presentation section 305 employs, in the scatter diagram, different presentation modes for the points representing that the overtime hours are not more than the specified threshold, i.e., points that satisfy the constraint, and for the points representing that the overtime hours exceed the threshold, i.e., points that do not satisfy the constraint.

For example, the information presentation section 305 may identify whether or not the constraint is satisfied by means of the colors of the points as in the display screen examples A1 and A2 of FIG. 9. For example, in the display screen example A1, point P1 and point P2 are different in color; this indicates that one of the points P1 and P2 satisfies the constraint and the other does not satisfy the constraint. Here, it is assumed that the point P1 does not satisfy the constraint and the point P2 satisfies the constraint.

Note that it may be determined in advance how to display a point which satisfies the constraint and how to display a point which does not satisfy the constraint. Further, the information presentation section 305 may indicate whether or not the constraint is satisfied by means of the saturation, lightness, gradation value, fill pattern, shape of the point (circle, square, etc.), size of the point, or the like, besides the color.

As described above, in the display screen example A1, the threshold may be changed with the slider SL. The display screen example A2 is a screen example in a case where the slider SL is moved in the right direction (the direction in which the threshold increases) from the state of the display screen example A1. In the display screen example A2, increasing the threshold increases the number of points satisfying the constraint, that is, points of the same display mode as the point P2.

In this way, the accepting section 302 accepts the specification of the threshold in the constraint, and the determination section 306 determines whether or not the constraint is satisfied based on the accepted threshold and the extracted variable. Then, the information presentation section 305 selects the presentation mode of the variable in the scatter diagram, which is the distribution information, in accordance with the determination result of the determination section 306. Accordingly, in addition to the example advantage achieved by the assistance apparatus 1 in accordance with the first example embodiment, the assistance apparatus 3 achieves an example advantageous of being capable of allowing the operator to easily recognize with which threshold set what kind of variable satisfies the constraint, and being capable of facilitating determination of the constraint including the threshold. The same applies to presentation of the distribution information of values obtained by substituting an extracted variable into a predetermined mathematical expression.

Further, in the display screen example A2, message M1 is displayed in association with the point P1. The message M1 indicates that the point P1 corresponds to a workman named “N”, and that the overtime hours exceed the specified threshold. As such, the information presentation section 305 may present the operator with the relevant information related to the variable which has been determined not to satisfy the constraint. The information presentation section 305 may similarly present the relevant information in the case of presenting the distribution information of a value obtained by substituting the extracted variable into a predetermined mathematical expression.

If it is known what kind of variable is a variable which has been determined not to satisfy the constraint, it is possible to easily determine a reasonable constraint. Therefore, according to the abovementioned configuration in which the relevant information related to a variable determined not to satisfy the constraint is presented, it is possible to achieve an example advantage of being capable of determining a constraint with reference to the relevant information.

Note that the relevant information only needs to be information related to a variable which has been determined not to satisfy the constraint, and is not limited to the example of FIG. 9. For example, the information presentation section 305 may present, as the relevant information: the date at which the overtime hours exceed the threshold; how much the overtime hours exceed the threshold; or the work system, job type, or the like of Mr. A.

### Flow of Processing

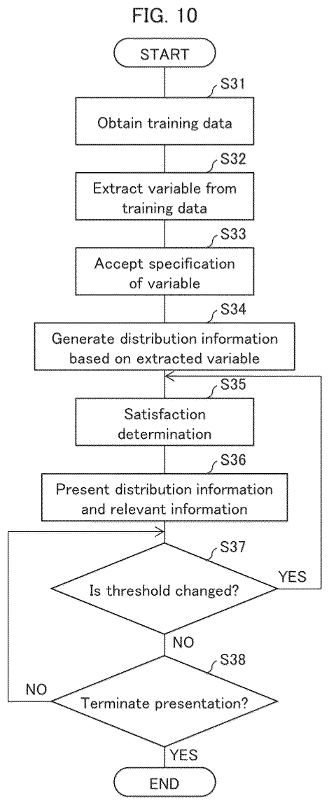

The following description will discuss the flow of processing carried out by the assistance apparatus 3 (assistance method) with reference to FIG. 10. FIG. 10 is a flowchart of an assistance method in accordance with the third example embodiment.

In S31, the data obtaining section 301 obtains training data for use in generation of an objective function. Subsequently, in S32, the variable extraction section 303 extracts variables corresponding to features of the objective function from the training data obtained in S31. Then, in S33, the accepting section 202 accepts specification of a variable. These processes are the same as those of S21 to S23 in FIG. 7. In the case of generating the scatter diagram as distribution information, in S33, the accepting section 202 may also accept specification as to which variables are assigned to the axes of the scatter diagram.

In S34, the reference information generation section 304 generates distribution information indicating the distribution of the variable specified in S33. As described above, the distribution information is reference information for determining a constraint for optimization calculation that uses the objective function generated by using the training data obtained in S31. The distribution information may be, for example, a scatter diagram as illustrated in FIG. 9.

In S35, the determination section 306 determines whether or not the variable extracted in S32 satisfies the constraint. For example, in a case where it is configured so that the threshold of the constraint can be specified with the slider bar SB1 illustrated in FIG. 9, the determination section 306 may determine that the variable of not more than the threshold indicated with the slider bar SB1 satisfies the constraint, and the determination section 306 may determine that the variable having a value exceeding the threshold does not satisfy the constraint.

In S36, the information presentation section 305 presents, to the operator, the determination result of S35 to the presentation mode of the variable in the distribution information generated in S34. Further, the information presentation section 305 generates relevant information in accordance with the determination result of S35 and presents the relevant information to the operator. Here, the relevant information may be presented triggered by, for example, operation or the like of the operator.

In S37, the accepting section 202 determines whether or not the threshold has been changed. For example, the accepting section 202 determines that the threshold has been changed in response to the operation of the slider bar SB1 illustrated in FIG. 9. If it is determined to be YES in S37, the operation returns to S35, and the determination section 306 carries out determination described above based on the changed threshold. On the other hand, if it is determined to be NO in S37, the operation proceeds to S38.

In S38, the accepting section 202 determines whether or not to terminate presentation of the reference information (here, distribution information). The termination condition of the presentation of the reference information may be determined in advance; for example, the accepting section 202 may determine to terminate the presentation upon accepting the operator's operation terminating the presentation of the reference information. If it is determined to be NO in S38, the operation returns to S37. On the other hand, if it is determined to be YES in S38, the operation of FIG. 10 is terminated.

### Variations

Any subject may carry out each process described in the foregoing example embodiments, and is not limited to the examples described above. For example, an assistance system having functions similar to those of each of the assistance apparatuses 1 to 3 can be constructed by a plurality of apparatuses that can communicate with each other. For example, an assistance system having functions similar to those of each of the assistance apparatuses 1 to 3 can be constructed by dispersedly providing, in a plurality of apparatuses, blocks illustrated in each of FIGS. 1, 4, and 8. Further, the processes in the flowcharts illustrated in, for example, FIGS. 2, 7, and 10 may be carried out by being shared by a plurality of information processing apparatuses (or processors).

### Software Implementation Example

The functions of part of or all of the assistance apparatuses 1 to 3 can be realized by hardware such as an integrated circuit (IC chip) or can be alternatively realized by software.

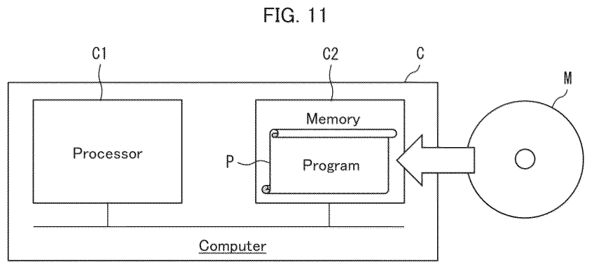

In the latter case, the assistance apparatuses 1 to 3 are realized by, for example, a computer that executes instructions of a program that is software realizing the foregoing functions. FIG. 11 illustrates an example of such a computer (hereinafter, referred to as “computer C”). The computer C includes at least one processor C1 and at least one memory C2. The memory C2 stores a program (assistance program) P for causing the computer C to operate as the assistance apparatuses 1 to 3. In the computer C, the processor C1 reads the program P from the memory C2 and executes the program P, so that the functions of the assistance apparatuses 1 to 3 are realized.

The processor C1 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory C2 can be, for example, a flash memory, a hard disk drive (HDD), a solid state drive (SSD), or a combination of these.

Note that the computer C may further include a random access memory (RAM) in which the program P is loaded if the program P is executed and/or in which various kinds of data are temporarily stored. The computer C may further include a communication interface via which data is transmitted to and received from another apparatus. The computer C may further include an input-output interface for connecting input-output apparatuses such as a keyboard, a mouse, a display and a printer.

The program P can be recorded in a non-transitory tangible storage medium M from which the computer C can read the program P. The storage medium M can be, for example, a tape, a disk, a card, a semiconductor memory, a programmable logic circuit, or the like. The computer C can acquire the program P via the storage medium M. The program P can be transmitted via a transmission medium. The transmission medium can be, for example, a communications network, a broadcast wave, or the like. The computer C can acquire the program P also via such a transmission medium.

### Additional Remark 1

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some of or all of the foregoing example embodiments can also be described as below. Note, however, that the present invention is not limited to the following supplementary notes.

### Supplementary Note 1

An assistance apparatus including: variable extraction means for extracting, from training data for use in generation of an objective function, a variable corresponding to a feature of the objective function; reference information generation means for generating, based on the extracted variable, reference information for determining a constraint for optimization calculation that uses the objective function; and information presentation means for presenting the reference information.

### Supplementary Note 2

The assistance apparatus according to Supplementary note 1, wherein the reference information generation means calculates a statistic of the extracted variable or a statistic of a value obtained by substituting the variable into a predetermined mathematical expression, and sets the calculated statistic as the reference information.

### Supplementary Note 3

The assistance apparatus according to Supplementary note 1, wherein the reference information generation means generates, as the reference information, distribution information indicating a distribution of the extracted variable or a distribution of a value obtained by substituting the variable into a predetermined mathematical expression.

### Supplementary Note 4

The assistance apparatus according to Supplementary note 3, further including: accepting means for accepting specification of a threshold in the constraint; and determination means for determining whether or not the constraint is satisfied based on the accepted threshold and the extracted variable, wherein the information presentation means sets a presentation mode of the variable or the value obtained by substituting the variable into the predetermined mathematical expression in the distribution information to a mode depending on the determination result.

### Supplementary Note 5

The assistance apparatus according to Supplementary note 4, wherein the information presentation means presents relevant information related to the variable which is determined not to satisfy the constraint or a value obtained by substituting the variable into the predetermined mathematical expression.

### Supplementary Note 6

The assistance apparatus according to any one of Supplementary notes 1 to 5, further including accepting means for accepting specification of the variable, wherein the reference information generation means generates the reference information based on the specified variable.

### Supplementary Note 7

The assistance apparatus according to any one of Supplementary notes 1 to 6, wherein the training data is sorted into a plurality of segments, the variable is variables extracted from the respective segments, and, based on the variables, the reference information generation means generates pieces of the reference information corresponding to the respective segments, and the information presentation means presents the pieces of the reference information for each segment.

### Supplementary Note 8

An assistance method including: extracting, by one or more processors, from training data for use in generation of an objective function, a variable corresponding to a feature of the objective function; generating, by the one or more processors, based on the extracted variable, reference information for determining a constraint for optimization calculation that uses the objective function; and presenting the reference information by the one or more processors.

### Supplementary Note 9

An assistance program that causes a computer to function as: variable extraction means for extracting, from training data for use in generation of an objective function, a variable corresponding to a feature of the objective function; reference information generation means for generating, based on the extracted variable, reference information for determining a constraint for optimization calculation that uses the objective function; and information presentation means for presenting the reference information.

### Additional Remark 3

Furthermore, some of or all of the above example embodiments can also be expressed as below. An assistance apparatus including at least one processor, the processor carrying out: a process of extracting, from training data for use in generation of an objective function, a variable corresponding to a feature of the objective function; a process of generating, based on the extracted variable, reference information for determining a constraint for optimization calculation that uses the objective function; and a process of presenting the reference information.

It should be noted that this assistance apparatus may further include a memory, which may store therein the assistance program for causing the at least one processor to carry out the process of extracting the variable, the process of generating the reference information, and the process of presenting the reference information. Alternatively, the assistance program may be stored in a computer-readable, non-transitory, tangible storage medium.

REFERENCE SIGNS LIST
1 Assistance apparatus
11 Variable extraction section
12 Reference information generation section
13 Information presentation section
2 Assistance apparatus
202 Accepting section
203 Variable extraction section
204 Reference information generation section
205 Information presentation section
3 Assistance apparatus
302 Accepting section
303 Variable extraction section
304 Reference information generation section
305 Information presentation section
306 Determination section

What is claimed is:

1. An assistance apparatus comprising at least one processor, the at least one processor carrying out:
a variable extraction process of extracting, from training data for use in generation of an objective function, a variable corresponding to a feature of the objective function;
a reference information generation process of generating, based on the extracted variable, reference information for determining a constraint for optimization calculation that uses the objective function; and
an information presentation process of presenting the reference information.

2. The assistance apparatus according to claim 1, wherein in_the reference information generation process, the at least one processor calculates a statistic of the extracted variable or a statistic of a value obtained by substituting the variable into a predetermined mathematical expression, and sets the calculated statistic as the reference information.

3. The assistance apparatus according to claim 1, wherein in_the reference information generation process, the at least one processor generates, as the reference information, distribution information indicating a distribution of the extracted variable or a distribution of a value obtained by substituting the variable into a predetermined mathematical expression.

4. The assistance apparatus according to claim the at least one processor further carrying out:
an accepting process of accepting specification of a threshold in the constraint; and
a determination process of determining whether or not the constraint is satisfied based on the accepted threshold and the extracted variable, wherein in the information presentation process, the at least one processor sets a presentation mode of the variable or the value obtained by substituting the variable into the predetermined mathematical expression in the distribution information to a mode depending on the determination result.

5. The assistance apparatus according to claim 4, wherein in the information presentation process, the at least one processor presents relevant information related to the variable which is determined not to satisfy the constraint or a value obtained by substituting the variable into the predetermined mathematical expression.

6. The assistance apparatus according to claim 1, further comprising the at least one processor further carrying out an accepting means for process of accepting specification of the variable, wherein in the reference information generation process, the at least one processor generates the reference information based on the specified variable.

7. The assistance apparatus according to claim 1, wherein
the training data is sorted into a plurality of segments, the variable is variables extracted from the respective segments, and, based on the variables, in the reference information generation process, the at least one processor generates pieces of the reference information corresponding to the respective segments, and
in the information presentation process, the at least one processor presents the pieces of the reference information for each segment.

8. An assistance method comprising:
extracting, by at least one processor, from training data for use in generation of an objective function, a variable corresponding to a feature of the objective function;
generating, by the at least one processor, based on the extracted variable, reference information for determining a constraint for optimization calculation that uses the objective function; and
presenting the reference information by the at least one processor.

9. A computer-readable non-transitory storage medium that stores a program that for causing a computer to function as an assistance apparatus, the program causing the computer to carry out:
a variable extraction means for process of extracting, from training data for use in generation of an objective function, a variable corresponding to a feature of the objective function;
a reference information generation process of generating, based on the extracted variable, reference information for determining a constraint for optimization calculation that uses the objective function; and
an information presentation process of presenting the reference information.
